(19) United States
(12) Patent Application Publication
(10) Pub. No.: US 2026/0105273 A1
(43) Pub. Date: Apr. 16, 2026

(54) SYSTEMS AND METHODS FOR DISTRIBUTING ENTITLEMENTS USING PHYSICAL OBJECTS

(71) Applicant: SONY INTERACTIVE ENTERTAINMENT LLC, SAN MATEO, CA (US)

(72) Inventor: Melissa Soucie, San Mateo, CA (US)

(21) Appl. No.: 18/913,118

(22) Filed: Oct. 11, 2024

(51) Int. Cl. G06K 7/14; G06K 7/10; G06Q 20/18

(52) U.S. Cl. CPC G06K 7/1417; G06K 7/10297; G06Q 20/18

(57) ABSTRACT

A method for distributing entitlements to users includes detecting that a card has been docked with a first handheld device of a first user, wherein the first handheld device is configured to releasably hold and display the card while in a docked state, reading a unique code from the card using the first handheld device, transmitting the unique code from the first handheld device to a server associated with a database of user accounts, associating within the database an account of the first user and the unique code, and providing an entitlement to the first user in at least one of a digital environment or physical environment responsive to the account of the first user and the unique code being associated.

### BACKGROUND

### 1. Field of the Disclosure

The present disclosure generally relates to digital environments, such as video games. More specifically, the present disclosure relates to systems and methods for distributing entitlements via collectible physical objects.

### 2. Description of the Related Art

In recent years, video game consoles and other gaming platforms have been transitioning away from removable discs, such as DVD and Blu-Ray discs, for the installation of software. Many video games are now delivered primarily as digital downloads over the Internet. In fact, Sony Corporation offers an all-digital version of its popular PS5 console that lacks a disc drive.

However, there is still a sizable percentage of users who enjoy collecting a tangible representation of a video game, such as a disc and its associated packaging, which often includes artwork, maps, and other elements that enhance the gaming experience. In addition, some users miss the social aspects of purchasing games at retail stores, where they were able to view trailers or play demos and otherwise interact with fans of particular consoles or game franchises. The elimination of discs and other physical collectables, as well as retail outlets that sell such collectables, is seen by many users as a negative consequence of the transition to digital downloads. In addition, such trends represent a lost opportunity for game companies to facilitate social interaction and gaming communities, which lead to greater user engagement and increased sales.

Currently, in-game sales are becoming a larger proportion of gaming revenue. While playing a video game, a user may be given an opportunity to purchase items, upgrades, or downloadable content (DLC) that are difficult or impossible to obtain through gameplay alone. Such virtual purchases have no physical component, and certain users may be less willing to spend money on items that have no tangible form of collectible. Furthermore, transferring items or other entitlements between users can be difficult or impossible in conventional gaming ecosystems since such items or other entitlements are purchased in-game and are permanently associated with the purchasing user's account.

### SUMMARY

Embodiments of the present disclosure include systems and methods for distributing entitlements to one or more users via collectible physical objects.

According to one aspect, a method for distributing entitlements includes detecting that a card has been docked with a first handheld device of a first user, where the first handheld device is configured to releasably hold and display the card while in a docked state. The method also includes reading a unique code from the card using the first handheld device. In addition, the method includes transmitting the unique code from the first handheld device to a server associated with a database of user accounts. The method further includes associating within the database an account of the first user and the unique code. The method also includes providing an entitlement to the first user in at least one of a digital environment or a physical environment responsive to the account of the first user and the unique code being associated.

In some configurations, the digital environment comprises a video game, and the entitlement includes one or more of an item, a skin, a resource, an achievement, or access to at least a portion of the video game. In other configurations, the entitlement includes providing the first user with entry to a location within the physical environment.

In various implementations, the method further includes one or more initial steps of associating the unique code with the entitlement or storing the unique code in the card in response to the first user purchasing the entitlement at a kiosk, the first user winning a challenge in the digital environment, or the first user bringing the card into proximity with a wireless transmitter in the physical environment.

In certain examples, the entitlement includes access to at least a portion of a video game, and providing the entitlement to the first user comprises preloading the at least a portion of the video game on a video game system of the first user.

In additional examples, the method further includes providing the entitlement to a second user in response to detecting that the card has been docked with a second handheld device of the second user. In some configurations, the method also includes removing the entitlement from the first user in conjunction with providing the entitlement to the second user.

In certain implementations, the method further includes providing the entitlement to at least one other user who previously owned the card or whose user account was previously associated with the card or the unique code in the database. In other implementations, the method further includes providing the entitlement to each user who previously owned the card or whose user account was previously associated with the card or the unique code in the database.

According to another aspect, a system for distributing entitlements to one or more users includes at least one processor and at least one memory programmed with instructions that cause the at least one processor to detect that a card has been docked with a first handheld device of a first user, where the first handheld device is configured to releasably hold and display the card while in a docked state. The instructions also cause the at least one processor to read a unique code from the card using the first handheld device. The instructions further cause the at least one processor to transmit the unique code from the first handheld device to a server associated with a database of user accounts. In addition, the instructions cause the at least one processor to associate within the database an account of the first user and the unique code. Furthermore, the instructions cause the at least one processor to provide an entitlement to the first user in at least one of a digital environment or a physical environment responsive to the account of the first user and the unique code being associated.

### BRIEF DESCRIPTION OF THE DRAWINGS

The accompanying figures are provided by way of illustration and not by way of limitation. The foregoing aspects are explained in the following description, taken in connection with the accompanying example figures relating to one or more embodiments, in which:

FIG. 1A illustrates a physical object for distributing an entitlement within a digital environment;

FIG. 1B illustrates another physical object for distributing the entitlement within the digital environment;

FIG. 2 is a block diagram of a system for distributing the entitlement within a digital environment;

FIG. 3A is a block diagram of a system for distributing cards;

FIG. 3B is a block diagram of a system for adding an entitlement to a user's card;

FIG. 3C is block diagram of a system for associating one or more entitlements with a user's account;

FIGS. 4A, 4B, 4C, and 4D illustrate configurations of a display dock;

FIG. 5 is a block diagram of a card with an integrated display;

FIGS. 6A, 6B, 6C, 6D, 6E, and 6F are illustrations of graphics and text on the integrated display of one or more cards;

FIG. 7A is a block diagram of system for using the integrated display of a card as a secondary display;

FIG. 7B illustrates an image being extended over multiple docked cards;

FIG. 8A is a block diagram of a system for notifying a user of the proximity of a wireless transmitter;

FIGS. 8B and 8C illustrate transferring an entitlement from one user to another user using at least one card; and

FIG. 9 is a flowchart of a method for providing an entitlement to a user via a card;

FIGS. 10A, 10B, 10C, and 10D are block diagrams of systems for distributing entitlements to a user in one or more of a digital or physical environment; and

FIG. 11 is a block diagram of an exemplary electronic entertainment system for implementing aspects of the present disclosure.

### DETAILED DESCRIPTION

The following embodiments describe systems and methods for distributing entitlements, such as items, skins, challenges, games, and game areas, within digital or physical environments using collectible physical objects. It will be understood, however, to one skilled in the art, that the present invention may be practiced without some or all of these specific details. In other instances, well known components and processes have not been described to avoid obscuring more relevant details.

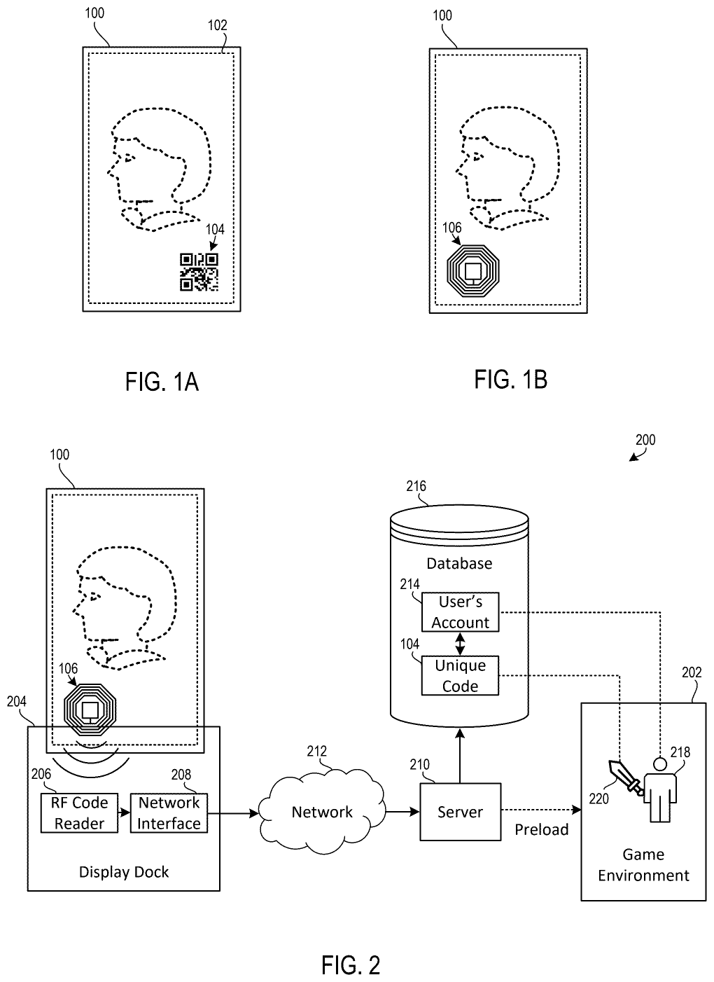

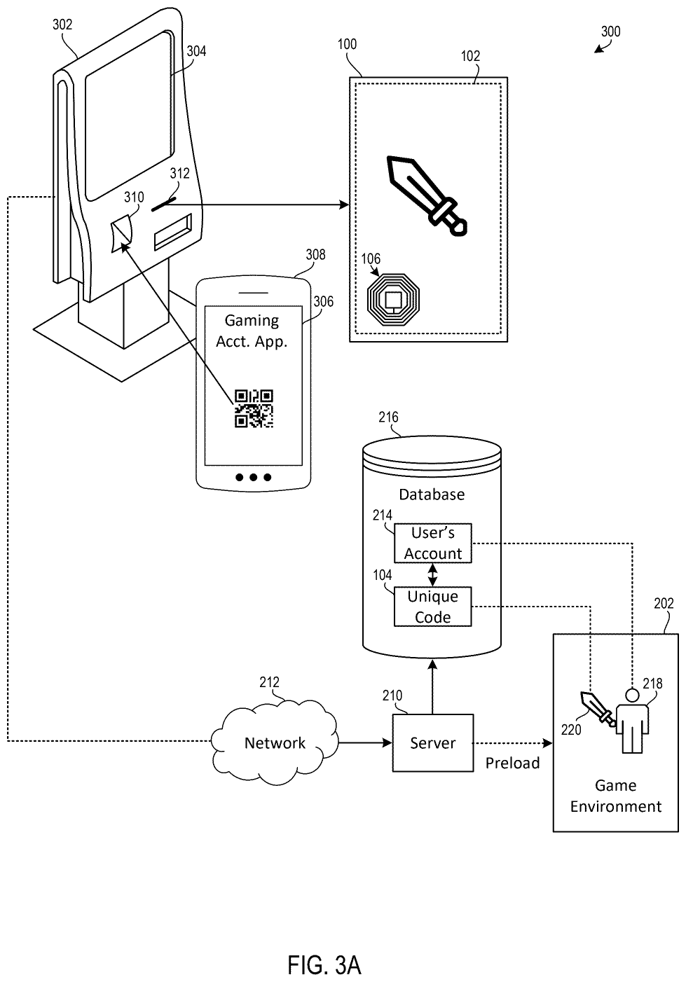

FIG. 1A illustrates a physical object for distributing entitlements within a digital environment, such as a video game. The physical object may be embodied as a card 100, which may be rectangular and relatively thin compared to its length and width. Cards 100 may be constructed using any suitable material, e.g., PVX, metal, reinforced and/or recycled plastic, and sold or otherwise distributed at retail outlets, kiosks, or online.

A variety of physical objects may be used within the scope of the present disclosure that are not limited to the form factor of a card. For example, the physical object could be an action figure, a model of a vehicle, or any solid object that is capable of being handled and displayed. For ease of description, the physical object will be described hereafter as a card 100, recognizing that the term can be more broadly construed.

In some embodiments, the card 100 may include artwork 102 printed on the surface of the card 100. The artwork 102 may be associated with a particular video game, depicting, e.g., a character, a faction, a location, a scene, and/or an item from the video game. In certain embodiments, a set of cards 100 may be associated with a particular video game or gaming franchise. In various configurations, the artwork 102 may be selected and/or provided by a purchaser of the card 100.

The artwork 102 may be applied to the card 100 using one or more of a variety of technologies, e.g., digital printing, which uses inkjet technology to create high-quality images directly on plastic; laser printing, which uses a high-powered laser to etch a design into the plastic; screen printing, which uses a stencil or mesh screen to transfer ink onto the plastic; UV litho printing, which uses ultraviolet light to cure or dry ink on a variety of surfaces; pad printing, which uses a silicone pad to transfer ink from an etched plate onto a 2D surface or 3D plastic object; flexo printing, which uses flexible photopolymer print forms for direct printing; and/or offset printing, which can produce high-quality prints on plastic and other substrates.

In some implementations, the card 100 includes a unique code 104 printed on the surface of the card 100 using a technique similar to or different from the artwork 102. As shown in FIG. 1A, the unique code 104 may be printed in the form of a QR code, which is a type of two-dimensional matrix barcode. However, any kind of human-readable text or machine-readable barcode may be used to represent the unique code 104 on the card 100. In certain embodiments, the unique code may be a GUID (globally unique identifier), which is a 128-bit text string that can uniquely identify the card 100. The unique code 104 may represent an entitlement or set of entitlements and/or the card 100 or the user (e.g., the owner of the card 100).

Alternatively, as shown in FIG. 1B, the unique code 104 may be embedded or stored within a radio frequency (RF) tag 106, such as a radio frequency identification (RFID) tag. RFID tags are small devices that use radio waves to identify, track, and communicate with objects. They can store a variety of information, such as serial numbers, short descriptions, and other data. Some RFID tags also have cryptographic security features for authentication and verification. The depicted RF tag 106 may include a memory device to store the unique code 104, as well as an antenna for communicating with and/or receiving power from a reader device (not shown). A variety of technologies besides RFID may be used, such as near field communication (NFC) and/or Bluetooth.

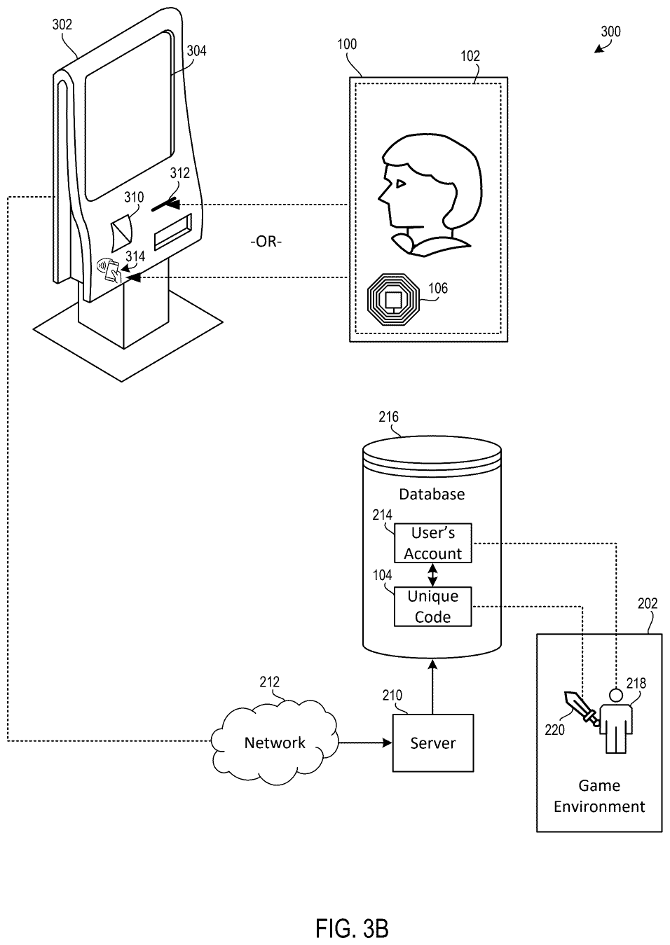

FIG. 2 is a high-level block diagram of a system 200 for distributing an entitlement within a digital environment 202 (e.g., video game) using a collectible physical object (e.g., card 100). The card 100 may be inserted into a handheld accessory, such as a display dock 204, which securely and releasably holds and displays the card 100. The display dock 204 may include a radio frequency (RF) code reader 206, which is capable of reading the unique code 104 from the RF tag 106. For example, if the RF tag 106 is an RFID tag, the RF code reader 206 may be an RFID reader, while if the RF tag 106 is a NFC or Bluetooth tag, the RF code reader 206 may be an NFC or Bluetooth tag reader, respectively. In some embodiments, multiple RF code readers 206 may be included within the display dock 204 to read different kinds of RF tags 106.

The RF code reader 206 may provide the unique code 104 to a network interface 208, which is capable of sending the unique code 104 to a server 210 through a network 212, such as the Internet. The network interface 208 may implement any suitable protocol(s), e.g., IEEE 802.11x, LTE, TCP/IP, UDP. Along with the unique code 104, the network interface 208 may send identifying information (e.g., a user identifier) to identify the owner of the display dock 204. The server 210 may then associate the unique code 104 with an account 214 of the user (based on the user identifier) in a database 216. The database 216 may be embodied as any type of database known in the art, such as a relational database, an object-oriented database, a hierarchical database, a “cloud” database, a NoSQL database, or the like. In some configurations, the database 216 may be implemented using blockchain technology to provide to enhance data integrity, transparency, and immutability. The user account 214 and/or database 216 may be components of a gaming network, such as the PlayStation Network™ (PSN).

Within the digital environment 202, associating the unique code 104 with the user account 214 may have the effect of unlocking the entitlement for the user within the digital environment 202. In some embodiments, unlocking the entitlement may include providing a user with the entitlement, e.g., resource, feature, or other unlockable, such as an item or skin, or a challenge or area within the digital environment 202. In certain configurations, the unique code 104 may unlock the digital environment (e.g., video game), itself. Of course, the user's account 214 may be associated with multiple unique codes 104 providing the user with multiple entitlements 220.

As an example, as shown in FIG. 2, the digital environment 202 may be a game environment, such as an RPG video game, in which the user is graphically represented by an avatar 218. The unique code 104 may unlock and provide to the user's avatar 218 the associated entitlement 220, such as a sword. In certain embodiments, when the unique code 104 is associated with the user's account 214, the entitlement 220 becomes permanently or temporarily unlocked for the user within the digital environment 202. In other embodiments, the entitlement 220 is unlocked as long as the card 100 is docked, i.e., removal of the card 100 from the display dock 204 may remove and/or re-lock the entitlement 220 for the user within the digital environment 202.

In another embodiment, the display dock 204 may be replaced with a portable user device, such as a smartphone or tablet. The smartphone or tablet may read the unique code 104 from the card 100 using a built-in camera or NFC or Bluetooth reader. The unique code 104 may then be sent to the server 210 via a cellular network and/or the Internet in the manner described above.

In some implementations, the entitlement 220, when associated with the user's account 214, may be automatically preloaded into the digital environment 202. For example, if the entitlement 220 is an item, the next time the user plays the video game, the user's avatar 218 will have the item in their inventory. If the entitlement 220 is a portion of the video game (e.g., DLC) or even the video game, itself, the video game or portion thereof may be preloaded onto the user's gaming device, either wirelessly or through a wired connection.

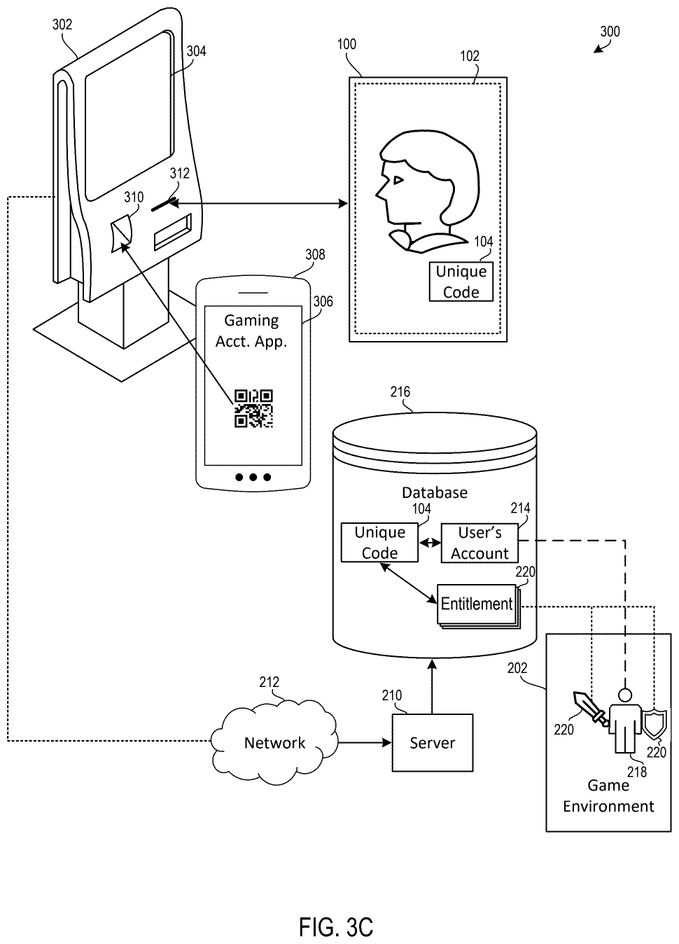

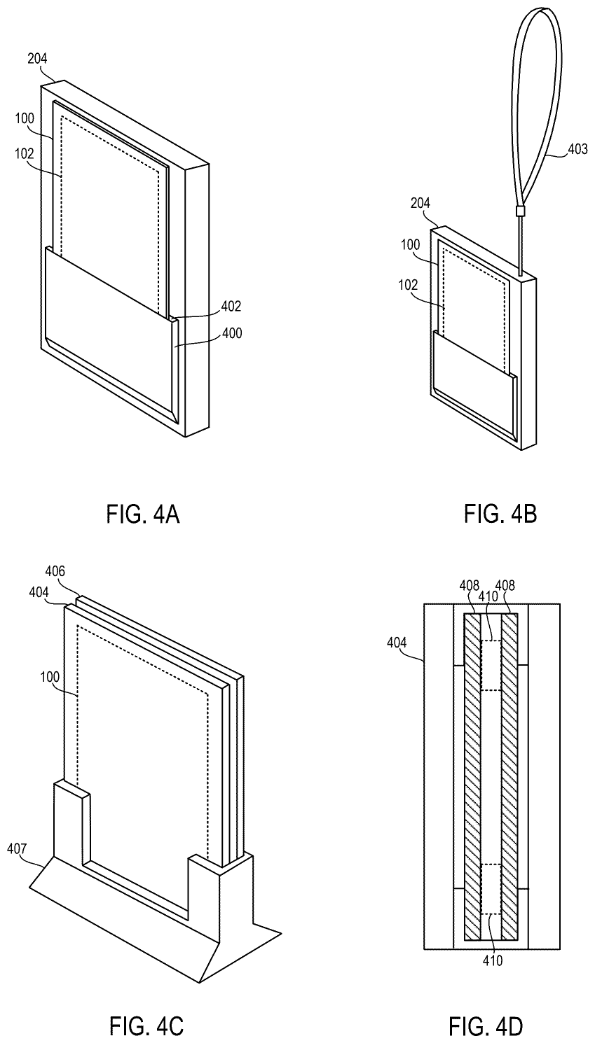

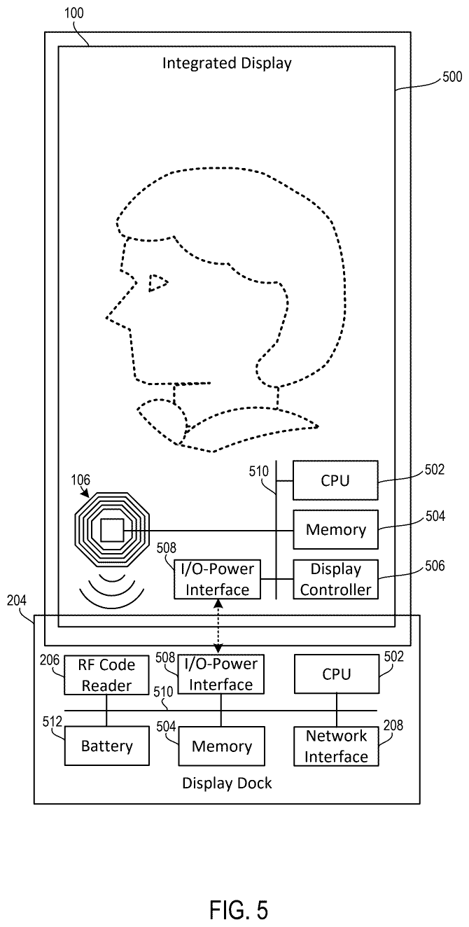

FIG. 3A illustrates a system 300 for distributing cards 100 in accordance with an embodiment of the present disclosure. The system may include a kiosk 302, which holds a number of cards 100 that have been pre-printed with various artwork. The kiosk 302 may include a touch-sensitive display 304 capable of displaying text, graphics, and video, and receiving user selections in response to the user touching various graphical elements. The user may authenticate with the kiosk 302 by providing a user name and password via the touch-sensitive display 304.

Alternatively, the user may have previously authenticated with a gaming account application 306 (e.g., PSN application) running on a portable user device 308, such as a smart phone. Upon being authenticated on the user device 308, the gaming account application 306 may display a QR code, which may be read by a code scanner 310 (e.g., camera or laser scanner) within the kiosk 302. In other embodiments, the portable user device 308 may communicate with the kiosk 302 using a wireless communication technique, such as WiFi, NFC, or Bluetooth.

The user may then operate the touch-sensitive display 304 to view available cards 100 and/or entitlements 220. Some cards 100 may be pre-associated with unique codes 104 for particular entitlements 220, such as items, skins, or the like. Other cards 100 may have no pre-associated entitlements 220, and a user may select, via the touch-sensitive display 304, one or more entitlements 220 to purchase and associate with a desired card 100. By means of the touch-sensitive display 304, the user may also watch trailers or other descriptive videos or text describing the purchase options.

As an example, a user may wish to purchase an entitlement 220, such as a particular sword for a video game that the user owns. The user selects a card 100 having artwork 102 depicting the sword. The card 100 may have been pre-associated with a unique code 104 that, when associated with the user's account, will provide the sword to the user's character (e.g., avatar 218). Assuming that the kiosk 302 has a card 100 in its inventory with the desired artwork 102, the kiosk 302 may retrieve the card 100 and verify the unique code 104 using a code reader (not shown) as described in connection with FIG. 2. Thereafter, the kiosk 302 may transmit the unique code 104 to the server 210 via the network 212, such that the unique code 104 is associated with the user's account 214, as previously described. The kiosk 302 may then issue the card 100 to the user via a vending slot 312. In some embodiments, as noted in connection with FIG. 2, the entitlement 220, when associated with the user's account 214, may be automatically preloaded into the game environment 202 on the user's game console.

In another configuration, as shown in FIG. 3B, the user may already own a card 100 depicting a character from a particular video game and want to associate an entitlement 220, such as a sword, with the card 100. In such an embodiment, the user may insert the card 100 into the vending slot 312 and/or tap the card 100 on a tap sensor 314. The user may then select the entitlement 220 to be added and check out in the same manner described in FIG. 3A. The primary difference is that a new card 100 is not issued to the user. Rather, the unique code 104 for the desired entitlement 220 may be written to the RF tag 106 of the user's card 100. Alternatively, as discussed below in connection with FIG. 3C, a unique code 104 representing the user's card 100 may be associated in the database 216 with the purchased entitlement 220.

FIG. 3C illustrates yet another configuration in which the unique code 104 (whether embodied as a barcode or RF tag) represents the card 100, itself, or the user, rather than a particular entitlement 220. The unique code 104 may be associated in the database 216 with the user's account 214, as discussed in connection with FIG. 3A. However, the unique code 104 may be further associated in the database 216 with one or more entitlements 220. As illustrated, this may allow the unique code 104 to function as a repository of multiple entitlements 220 (e.g., items), such as a sword and shield.

The entitlement(s) 220 may be pre-associated with the unique code 104 or associated with the unique code 104 when the user selects the entitlement(s) 220 for purchase, either at the time the card 100 is distributed by the kiosk 302 or subsequently thereto. For example, the user may later add entitlements 220 to the card 100 by winning challenges, through in-game purchases, or the like. The entitlements 220 may likewise be represented by codes, which may or may not be unique, for identification purposes within the database 216.

Reference herein to providing the entitlement 220 to the user responsive to the user's account 214 and the unique code 104 being “associated” should be broadly construed to include either that the unique code 104 represents the entitlement 220 (e.g., FIG. 3A) or that the unique code 104 represents the card 100 (or the user), which, in turn, is associated with the entitlement 220 within the database 216 (e.g., FIG. 3C).

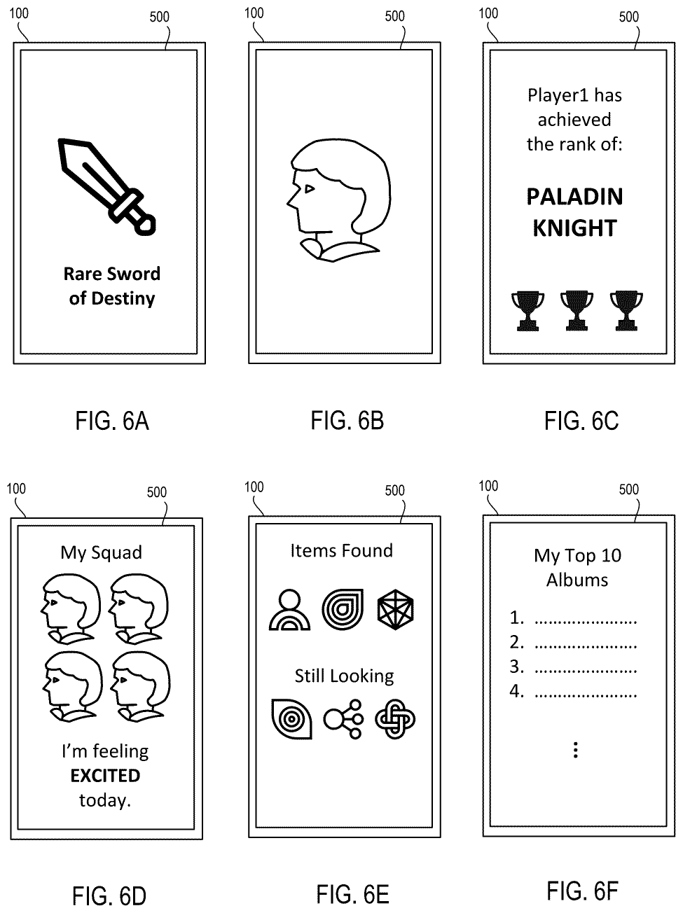

FIGS. 4A-4C illustrate various configurations of the display dock 204, which may be used not only to display the card 100 and its artwork 102, but also to facilitate transmission of the unique code 104 to the server 210 for association with the user's account 214.

For example, FIG. 4A illustrates a display dock 204 including a receptacle 400 for holding the card 100 when it is in a docked state. In the illustrated configuration, the receptacle 400 includes a slot 402 for insertion of the card 100. The slot 402 and/or the receptacle 400 are configured (e.g., provided suitable length, width, depth, materials, and/or securing mechanisms) to securely and releasably hold the card 100 when docked by means of friction and/or gravity. A proximal face of the receptacle 400 (i.e., a portion of the receptacle facing away from the display dock 204) may be transparent so as to not obscure the artwork 102 printed on the card 100. Alternatively, the depth of the receptacle 400 may be sufficiently shallow so as to not obscure the artwork 102 on the card 100 while still securely holding the card 100. The display dock 204 may be constructed from any suitable material, such as plastic (e.g., PET, HDPE, PVC, LDPE, PP, PC), glass, or Plexiglass® (acrylic). FIG. 4B illustrates a similar display dock 204 which additionally includes a wrist strap 403 or lanyard for easy carrying.

FIG. 4C illustrates another configuration of the display dock 204 suitable for displaying the card 100 on a desk or shelf in an upright orientation. The display dock 204 of FIG. 4C includes a viewing (front) layer 404 and a backing layer 406. At least the viewing layer 404 may be transparent to allow the card 100 to be viewed through the viewing layer 404 while in a docked state. The distance between the viewing layer 404 and the backing layer 406 may be sufficient to securely and releasably hold the card 100 between the layers 404, 406 by friction and/or gravity.

The display dock 204 may further include a base component 407 sized to receive and securely hold the viewing layer 404 and the backing layer 406 at a predetermine distance. As illustrated in the top-down view of FIG. 4D, the base component 407 may include slots 408 and/or spacers 410 to hold the viewing layer 404 and backing layer 406 at the predetermined distance. In other configurations, the viewing layer 404 and backing layer 406 may form the front and rear portions of a transparent receptacle 400 that encloses the card 100 on at least four sides.

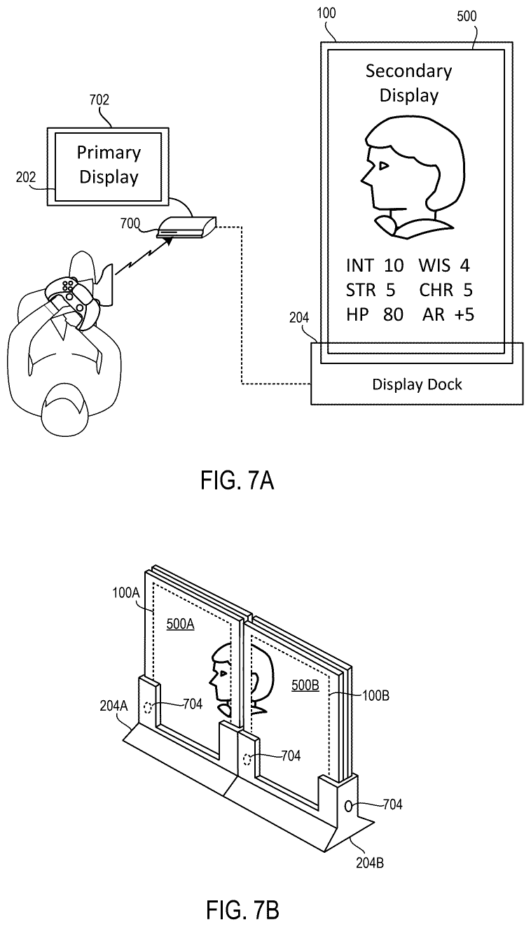

FIG. 5 illustrates a configuration of a card 100, which includes an integrated display 500 as an alternative (or in addition) to the printed artwork 102. The integrated display 500 may include an optically rewritable liquid crystal display (ORWLCD) or an e-ink display, both of which maintain images without the need for a battery or other power source when the card 100 is undocked from the display dock 204. Alternatively, or in addition, the integrated display 500 may be an electrophoretic or microencapsulated electrophoretic display, an electrowetting display, an electrofluidic display, a Gyricon™ display, or other suitable display technology.

In addition to the RF tag 106, the card 100 may include a CPU 502, a memory 504, a display controller 506, and an I/O-power interface 508. All of the foregoing components may communicate, in one configuration, via a bus 510. The CPU 502 may be any suitable microprocessor, microcontroller, field-programmable gate array (FPGA), or application-specific integrated circuit (ASIC) known in the art. The memory 504 may include any suitable combination of random access memory (RAM), read-only memory (ROM), electrically-erasable programmable read-only memory (EEPROM), cache memory, or the like. The display controller 506 may be adapted to the specific technology used by the integrated display 500 and facilitate rendering of image data stored in the memory 504.

The I/O-power interface 508 may facilitate communication using wired or wireless transmission with a similar I/O-power interface 508 within the display dock 204. In some embodiments, the I/O-power interfaces 508 may facilitate transmission of power wirelessly or through a wired connection from the display dock 204 to the card 100. In some embodiments, at least the display dock 204 may include a battery 512 or other power source.

The display dock 204 may include the RF code reader 206, as discussed in connection with FIG. 2, as well as the network interface 208. The display dock 204 may further include a CPU 502, a memory 504, and a bus 510, each of which may be similar to (or different from) the components in the card 100. Certain components, e.g., CPU 502, may be included in either the card 100 or the display dock 204, or both, depending on the implementation. For example, a CPU 502 within the display dock 204 may control the components of the card 100 when docked, with the I/O-power interfaces 508 serving as extensions of a common bus 510 between the display dock 204 and the card 100.

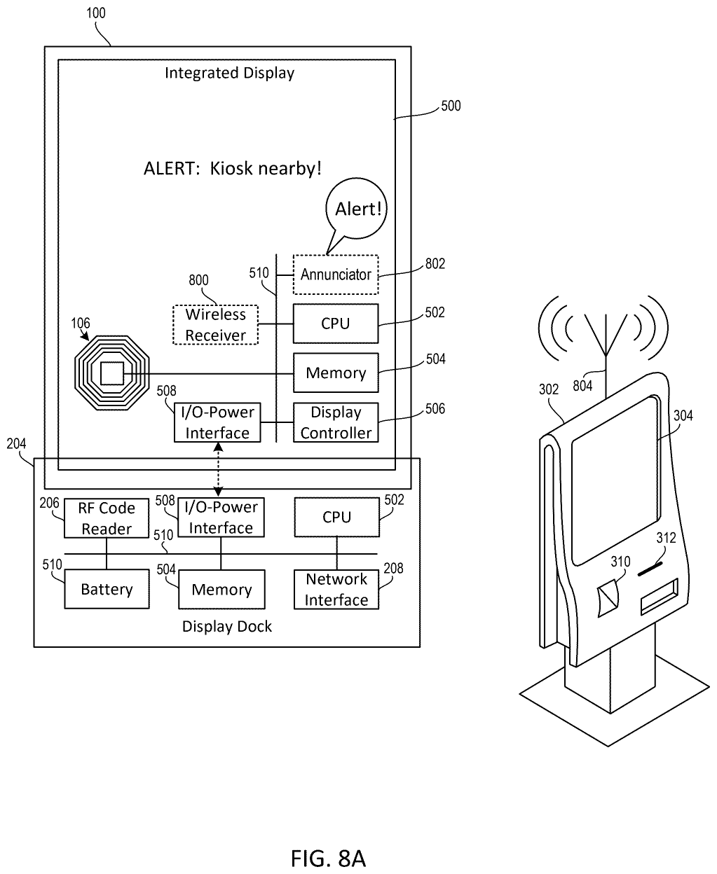

By means of the integrated display 500, digital artwork may be displayed or updated on the surface of the card 100 as desired. In some configurations, the integrated display 500 may display artwork indicative of an entitlement 220 (e.g., item) associated with the card 100, as shown in FIG. 6A. In other embodiments, as shown in FIG. 6B, the integrated display 500 may display artwork indicative of a character in the video game, e.g., non-player character (NPC) or player character (avatar).

In still other embodiments, as shown in FIG. 6C, the integrated display 500 may show a status or rank and/or one or more achievements (e.g., trophies, quests completed) of the user, which can be updated as the user progresses in the video game. Colors used in the displayed images may reflect the user's status or rank (e.g., gold, silver, bronze), health in the game (e.g., red, yellow, or green), or the like, which can be seen at a distance without being close enough to read the text or graphics on the integrated display 500.

Referring also to FIG. 5, responsive to a change in the user's status or achievements, an updated image reflecting the user's new status or achievements may be sent to the display dock 204 and temporarily stored in its memory 504. Under control of the display dock's CPU 502, the updated image may be transferred from the memory 504 of the display dock 204 to the memory 504 of the card 100, after which the display controller 506 may display the updated image on the integrated display 500.

In certain embodiments, as shown in FIG. 6D, the integrated display 500 may show picture(s) of the user, the user's avatar, the user's friends, team, or squad, or in-game images captured by the user. In some configurations, the integrated display 500 may display an expression of the user's current sentiment.

As shown in FIG. 6E, the integrated display 500 may be used in the context of a quest or scavenger hunt (in the real world or the digital environment 202) to show quest items that the user has found and has yet to find.

Referring to FIG. 6F, the integrated display 500 may be used to display any information that the user wishes to present, which may or may not relate to a particular video game. For example, the user may configure the integrated display 500 to show their top ten albums, which may be updated automatically based on the user's listening habits on a music streaming service.

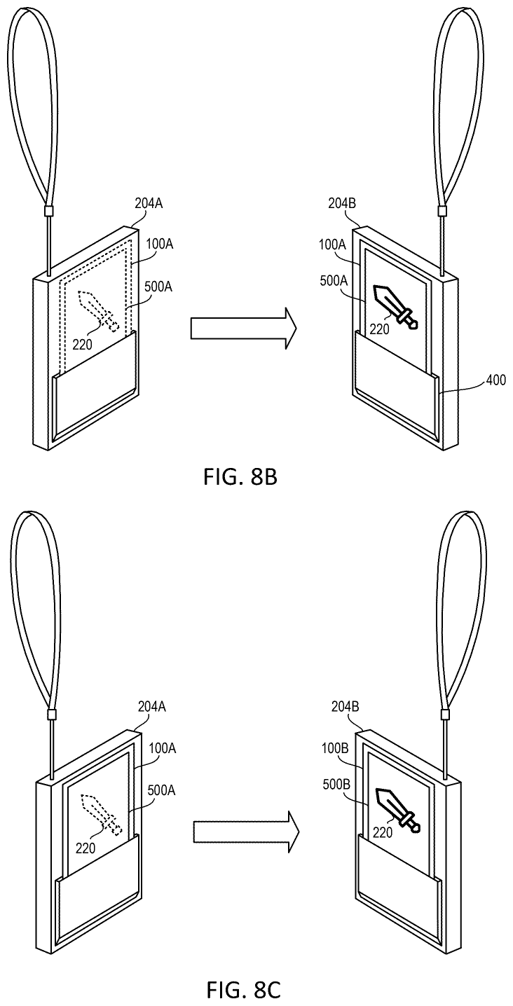

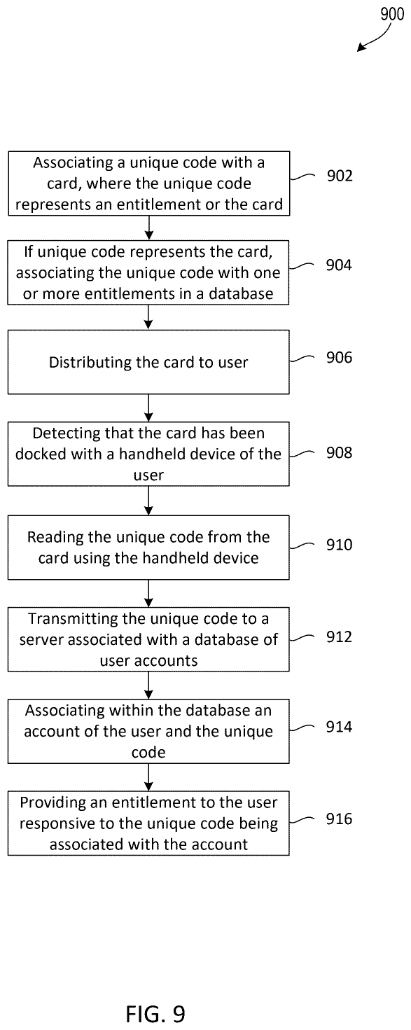

Referring to FIG. 7A, the user may navigate a digital environment 202 via a video game console 700 using a primary display 702 (e.g., television or computer monitor). In some embodiments, the display dock 204 may be in wired or wireless communication with the video game console 700, such that the integrated display 500 of the card 100 may function as a secondary display to enhance the user's enjoyment of the digital environment 202. For example, where the digital environment 202 is an RPG, the integrated display 500 may show the user's “stats,” an image of the user's avatar or items, and/or other useful information that would otherwise occupy a portion of the primary display 702.

As shown in FIG. 7B, multiple display docks 204A, 204B may be aligned side-by-side. Each display dock 204A, 204B may hold a respective card 100A, 100B, each of which may have an integrated display 500A, 500B, respectively. In one embodiment, the integrated displays 500A, 500B of the two cards 100A, 100B may operate in concert to extend an image over both integrated displays 500A, 500B, effectively doubling the display area when compared to single integrated display 500 of a card 100. Such an extension of the display area may be accomplished by the respective display controllers 506 of each card 100A, 100B (shown in FIG. 5).

In some embodiments, each display dock 204A, 204B may have one or more proximity sensors 704, such that when the proximity sensor 704 of one display dock 204A is touching or close to the proximity sensor 704 of another display dock 204B, the display controllers 506 of the respective cards 100A, 100B are automatically configured to extend an image over both integrated displays 500A, 500B as if they were a single integrated display 500. Of course, the integrated displays 500 of three (or more) cards 100 may be combined and/or extended when their respective display docks 204 are placed side-by-side allowing for arbitrarily large display areas.

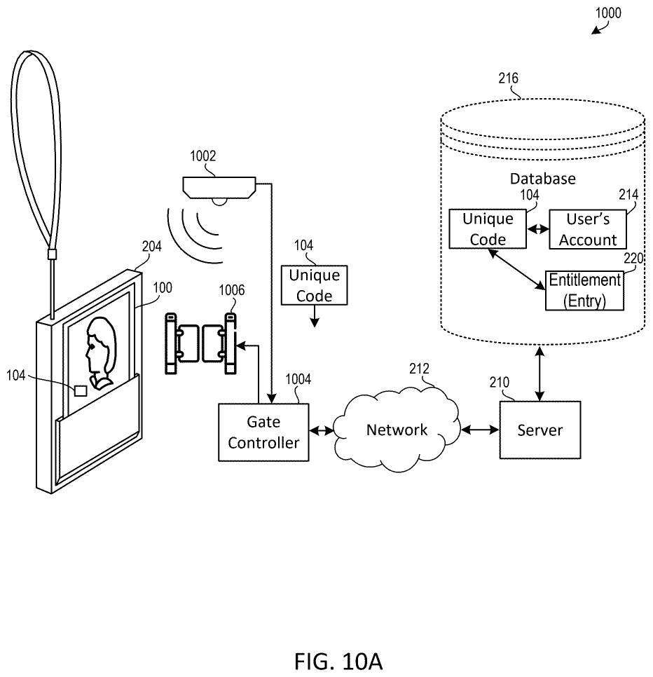

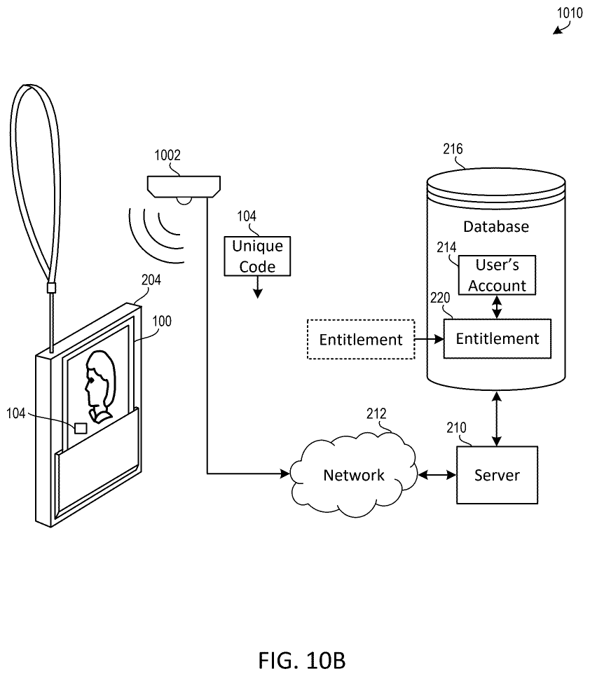

In one embodiment, as shown in FIG. 8A, the card 100 and/or the display dock 204 may include a wireless receiver 800 and/or an annunciator 802. The wireless receiver 800 detects the proximity of a wireless transmitter 804 in the local environment as the user carries the docked card 100. The annunciator 802 audibly or haptically notifies the user of the proximity of the wireless transmitter 804. Alternatively, or in addition, the integrated display 500 may function as an annunciator, graphically indicating that the wireless transmitter 804 is near. In some embodiments, the wireless receiver 800 may be implemented using the RF code reader 206 or the network interface 208 of the display dock 204, either of which may be configured to detect the existence (and strength) of certain RF signals.

As an example, the wireless transmitter 804 may be a Bluetooth transmitter deployed in a kiosk 302. As the user moves about the local environment, the wireless receiver 800 (or RF code reader 206 or network interface 208) detects an RF transmission from the wireless transmitter 804. The content of the RF transmission may indicate that the detected wireless transmitter 804 is associated with a nearby kiosk 302. As a result, the card 100 may be programmed to display a message, e.g., “ALERT: Kiosk nearby!” Alternatively or in addition, the annunciator 802 may be programmed to deliver a haptic notification (vibration) or audible message (including a spoken message in some cases), notifying the user of the existence of the nearby kiosk 302.

As another example, the aforementioned components may be used to alert the user to the proximity of nearby friends, each of whom may be carrying docked cards 100. For example, the network interfaces 208 of each friend's display dock 204 may serve as wireless transmitters 804. As the user moves about the local environment, the wireless receiver 800 (or RF code reader 206 or network interface 208) detects an RF transmission from the wireless transmitters 804 (or network interfaces 208). The RF transmission may include a code that identifies the owners of the respective cards 100. If one of the owners is a friend of the user, the user's card 100 may be programmed to display a message, e.g., “ALERT: Friend nearby!” Alternatively or in addition, the annunciator 802 may be programmed to deliver a haptic notification (vibration) or audible message (including a spoken message in some cases), notifying the user of the existence of the nearby friend.

Alternatively, the aforementioned components may be used in the context of a scavenger hunt, at a convention (e.g., ComicCon™), or in other ways where it is necessary or useful to alert the user to the existence of an item, person, or information in their vicinity marked by respective wireless transmitters 804. In certain embodiments, the user may receive achievements or trophies or certain entitlements 220 in response to visiting a real-word location marked by a particular wireless transmitter 804, which could be reflected on the integrated display 500 of the card 100, as shown in FIG. 6C.

FIG. 8B illustrates a technique for transferring an entitlement 220 from one user to another. In the illustrated embodiment, this may be accomplished by physically transferring a card 100 (e.g., card 100A) from the first user to the second user. The second user may insert the card 100A into the receptacle 400 of their display dock 204B. The process may then proceed as discussed in conjunction with FIG. 2, where the unique code 104 of the card 100A is read and sent to the server 210, where it is associated with the second user's account 214 in the database 216, unlocking the entitlement 220 for the second user.

In some embodiments, the server 210 will also disassociate the unique code 104 with the first user's account 214 in the database 216, effectively locking and/or removing access to the entitlement 220 for the first user. Of course, in certain embodiments, users may freely transfer multiple copies of an item or entitlement to other users through the transfer of a card 100, in which case the first user may retain the association between the unique code 104 and their account 214.

In various configurations, the first user may be prompted via, e.g., a text or email message, to approve the transfer of the card 100 (and any entitlements 220 or certain entitlements 220 associated therewith) to the second user. In other configurations, the first user may pre-approve the transfer the card 100A (and one or more entitlements 220) using an interface displayed on the card 100A, itself, which may include providing a password or PIN. For example, the card 100 and any associated entitlements 220 may be locked to prevent theft of the entitlements 220 if the card 100 is lost or stolen. Providing the password or PIN, for example, may unlock the entitlements 220 for transfer to the second user when the card 100 is physically transferred.

In another embodiment, as shown in FIG. 8C, the first user may transfer an entitlement 220 associated with a first card 100A to a second card 100B owned by the second user. In such a case, a physical transfer of cards may not be required. Instead, the user of the first card 100A may approve the transfer in a dialogue displayed on the first integrated display 500A. The second card 100B may be identified, for example, by bringing the second card and/or second display dock 204B in proximity to the first card 100A and/or the first display dock 204A. The wireless receiver 800 (or the RF code reader 206 or network interface 208) of the first user may detect the proximity of the second user's card 100B and/or display dock 204B and determine the account 214 of the second user. In some embodiments, this may be accomplished by tapping the first and second cards 100A, 100B, or the first and second display docks 204A, 204B.

In response, the method may proceed as discussed in connection with FIG. 2, where the unique code 104 of the card 100A is sent to the server 210 and associated with the second user's account 214 in the database 216, unlocking the entitlement 220 for the second user. In some embodiments, the server 210 will also disassociate the unique code 104 from the first user's account 214 in the database 216, effectively locking the entitlement 220 for the first user.

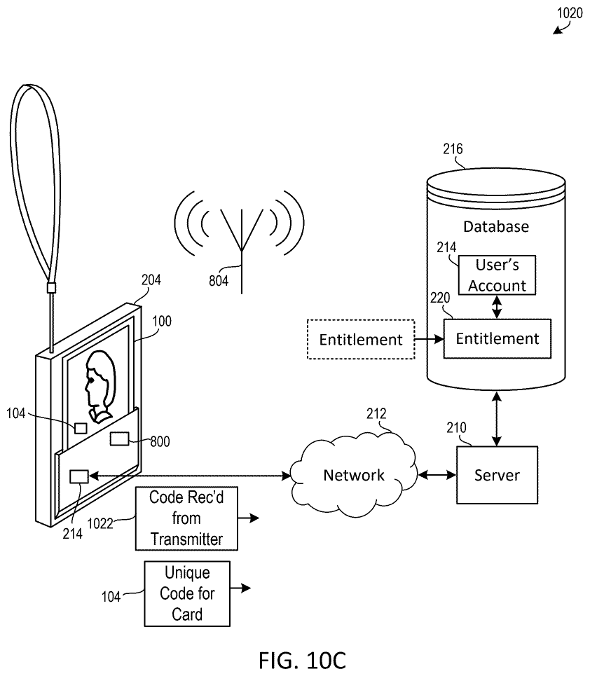

FIG. 9 is a flowchart of a method 900 for distributing entitlements via cards or other collectible physical objects. The method 900 may begin by associating 902 a unique code with the card. The unique code may represent a particular entitlement or set of entitlements. Alternatively, the unique code may represent the card, itself, as a repository of one or more entitlements.

In some embodiments, the entitlement represents a resource, feature, or other unlockable within a digital environment, such as a video game. For example, the entitlement may include, without limitation, an item, a skin, an upgrade, a character, a challenge, a virtual event, or access to at least a portion of the video game (including the video game in its entirety). In other embodiments, the entitlement pertains to the physical environment of a user, such as access to an event or providing some other benefit to the user within the real world. For example, the entitlement may permit the user to pass through a checkpoint into a concert, sporting event, or the like.

The unique code may be pre-printed on the card as a bar code, as shown in FIG. 1A. Alternatively, the unique code may be programmed into or stored within the RF tag (as shown in FIG. 1B) at the time of manufacture or written to a changeable memory of the RF tag at the time the card is distributed (e.g., via a kiosk, as discussed in connection with FIG. 3A) or at any point thereafter.

If the unique code represents the card rather than a particular entitlement, the method 900 may include associating 904 the unique code with one or more entitlements in a database. This may occur at the time of distributing 906 the card to a user, where the user may select the one or more entitlements to associate with the card. As an example, the user may purchase the card at a kiosk, as shown in FIG. 3A, where the user may pick a card with particular artwork and specify the entitlement(s) to be associated with the card.

Alternatively, the card could be given to the user at an event or in response to winning a challenge or accomplishing a task in the real or virtual world.

The method 900 may continue by detecting 908 that the card has been docked with a handheld device of the user. As illustrated in FIG. 2, the user may insert the card into a display dock configured to releasably hold and display the card while in a docked state. The display dock may be worn around the user's neck or wrist using a lanyard or wrist strap, as shown in FIG. 6B. Alternatively, the display dock may include a base component configured to hold the card in an upright orientation for display.

In certain configurations, the method 900 continues by reading 910 the unique code from the card using the first handheld device. Depending on how the unique code is associated with the card, e.g., bar code (FIG. 1A) or RF tag (FIG. 1B), the display dock may include hardware, e.g., camera, laser scanner, RF tag reader, for reading the unique code prior to or after the card is docked.

The method 900 may continue by transmitting 912 the unique code from the handheld device (e.g., display dock) to a server associated with a database of user accounts, as shown in FIG. 2. Identifying information regarding the owner of the card and/or display dock may additionally be provided to the server. The server and database of user accounts may be components of a gaming network, such as the PlayStation network (PSN). Thereafter, the method 900 may continue by associating 914 within the database an account of the user and the unique code.

Finally, the method 900 may continue by providing 916 the entitlement associated with the unique code to the user in at least one of a digital environment (e.g., game environment) or a physical environment (e.g., concert or other venue) responsive to the account of the user and the unique code being associated. For example, FIGS. 3A-3C illustrate providing one or more entitlements (e.g., sword and/or shield) in a digital environment responsive to the unique code and the user's account being associated.

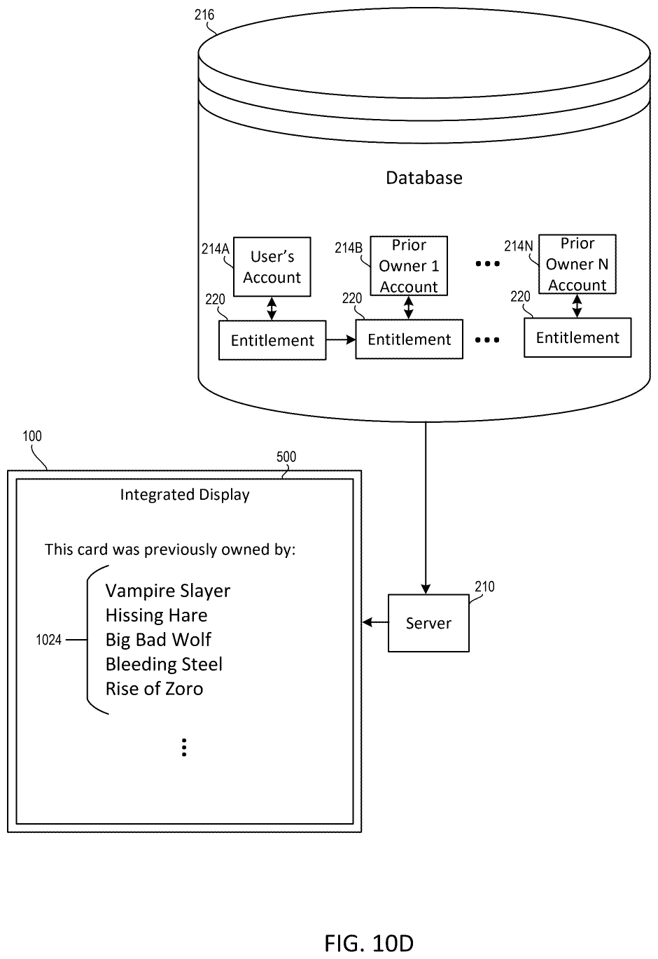

FIG. 10A is a block diagram of an example system 1000 for providing an entitlement to a user within a physical environment. In one configuration, the card 100 may be associated with a unique code 104 for the entitlement 220 (e.g., entry into a concert venue), which may be printed on the card as a barcode or stored within an RF tag 106. Alternatively, the unique code 104 may represent the card 100, which has been associated in a database 216 with the entitlement 220.

The card 100 may be docked with a display dock 204 and carried by the user to the venue. At the venue, a code reader 1002 (e.g., RF tag reader) reads the unique code 104 from the card 100 and provides the same to a gate controller 1004 for a security gate 1006 or turnstile. The gate controller 1004 may store or have access to a list of unique codes that grant the entitlement 220 (e.g., entry). Alternatively, the gate controller 1004 may be configured to determine algorithmically whether the unique code 104 is in a format to grant the entitlement 220. In still other configurations, the unique code 104 may not be directly associated with the entitlement 220, but, rather, represent the card 100 within the database 216, where the unique code 104 may be associated with the entitlement 220.

If the controller 1004 determines that the unique code 104 read by the code reader 1002 is associated with the entitlement 220, the gate controller 1004 may communicate with the security gate 1006 or turnstile to permit entry to the user. In some embodiments, the security gate 1006 may be unlocked only for the user carrying the card 100, after which the security gate 1006 may be automatically re-locked until another unique code 104 is read that grants the same entitlement 220.

FIG. 10B is a block diagram of an example system 1010 for providing a user with an entitlement 220 in response to activity in the user's physical environment, e.g., entry of the user into a particular area, winning a challenge, or the like. The system 1010 may include a code reader 1002 (e.g., RF tag reader) configured to read the unique code 104 from the card 100 when the user is in proximity to the code reader 1002. The code reader 1002 may provide the unique code 104 to a server 210 associated with a database 216 of user accounts 214. In response to receiving the unique code 104, the server 210 may associate the entitlement 220 with the user's account 214. The user's account 214 may be identified via the unique code 104 if it has been previously associated (e.g., registered) with the user's account 214. Alternatively, the user may identify themselves at a kiosk 302, as discussed in connection with FIG. 3A, such that the server 210 knows which user account 214 to associate with the entitlement 220.

FIG. 10C illustrates yet another system 1020 for providing an entitlement 220 to a user via a card 100 and associated display dock 204. In the illustrated embodiment, the card 100 may be associated with a unique code 104 that represents or otherwise identifies the card 100. The card 100 may be docked with the display dock 204 and carried by the user in the physical environment.

In one embodiment, a wireless transmitter 804 (such as the wireless transmitter of FIG. 8A) may broadcast an RF signal that may be received by a wireless receiver 800 within the display dock 204. The RF signal may include a code 1022, which may be temporarily stored within a memory of the card 100 and/or display dock 204.

Subsequently, the network interface 208 of the display dock 204 may transmit the code 1022 to the server 210 along with the unique code 104 identifying the card 100. In some configurations, the user's account 214 may be determined from the unique code 104, e.g., the unique code 104 may be registered with the user's account 214.

The server 210, upon receiving the code 1022 received from the wireless transmitter 804 and the unique code 104 may determine an entitlement 220 represented by the code 1022 and associate the entitlement 220 with the user's account 214.

In some embodiments, as illustrated in FIG. 10D, associating an entitlement 220 with a user's account 214A (e.g., through purchase or a receiving a reward) may also result in the entitlement 220 being associated with the accounts 214B-218N of some or all of the prior “owners” of the card 100, e.g., the users whose accounts 214B-218N have been previously associated with the card 100. This incentivizes the transfer of the card 100, since entitlements subsequently added to the card 100 by the next owner may inure to the benefit of the previous owner(s).

As noted in connection with FIG. 8B, a user may physically transfer (e.g., sell, loan, or otherwise provide) a card 100 to another user. The card 100 may be transferred again to another user, and so on, until the card 100 has been owned by N users and thereby associated with N prior user accounts 214B-214N.

In some configurations, only the previous owners who satisfied certain conditions may have the entitlement 220 associated with their accounts 214. Such conditions may include, without limitation, payment of a fee, reaching a particular rank, participating in a shared quest, registration of the card, and the like. In some cases, only X previous owners may receive the entitlement 220 added to their accounts 214, where X<N. For example, if the card 100 has been transferred fifty times, only the ten most recent owners may receive the entitlement 220.

In still other embodiments, purchasing or otherwise obtaining an entitlement 220 for a card 100 will result in the entitlement 220 being associated with the accounts 214 of all (or a subset of) subsequent purchasers, which may have the effect of making a card 100 more valuable with each purchase.

In certain configurations, as further illustrated in FIG. 10D, a list 1024 of the prior owners of the card by name and/or gamer tag (i.e., the card's provenance) may be displayable on the integrated display 500 of the card 100. The fact that the card 100 may be owned by a popular user may give bragging rights to the current user and further enhance the value of the card 100. The list 1024 may be stored in the database 216 and updated by the server 210 such that the integrity of the list 1024 may be maintained.

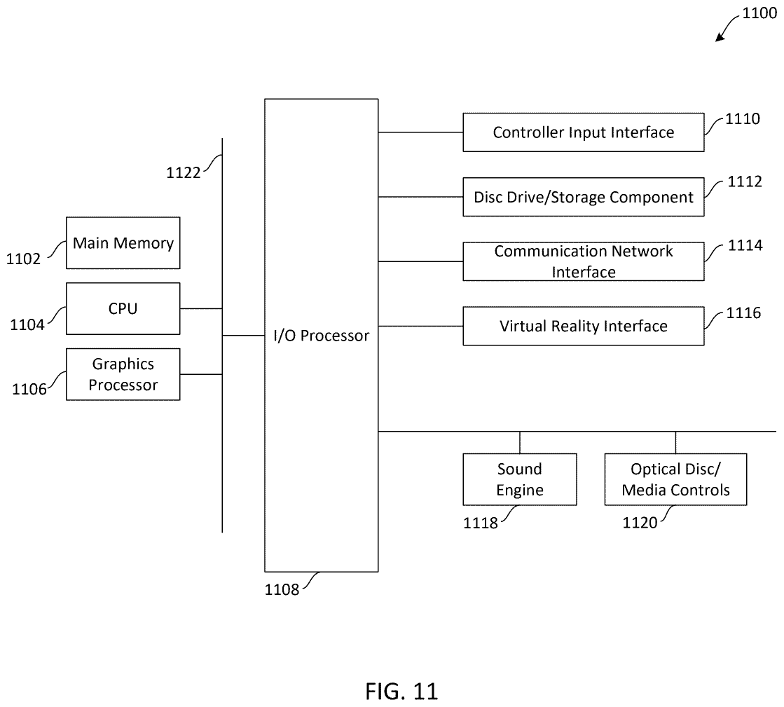

FIG. 11 is a block diagram of an exemplary electronic entertainment system 1100, which may be used to display and navigate the digital environment (e.g., game environment) shown in FIG. 2. The electronic entertainment system 1100 as illustrated in FIG. 11 includes a main memory 1102, a central processing unit (CPU) 1104, graphic processor 1106, an input/output (I/O) processor 1108, a controller input interface 1110, a hard disc drive or other storage component 1112 (which may be removable), a communication network interface 1114, a virtual reality interface 1116, sound engine 1118, and optical disc/media controls 1120. Each of the foregoing are connected via one or more system buses 1122.

Electronic entertainment system 1100 as shown in FIG. 11 may be an electronic game console. The electronic entertainment system 1100 may alternatively be implemented as a general-purpose computer, a set-top box, a hand-held game device, a tablet computing device, or a mobile computing device or phone. Electronic entertainment systems may contain some or all of the disclosed components depending on a particular form factor, purpose, or design.

Main memory 1102 stores instructions and data for execution by CPU 1104. Main memory 1102 can store executable code when the electronic entertainment system 1100 is in operation. Main memory 1102 of FIG. 11 may communicate with CPU 1104 via a dedicated bus. Main memory 1102 may provide pre-stored programs in addition to programs transferred through the I/O processor 1108 from hard disc drive/storage component 1112, a DVD or other optical disc (not shown) using the optical disc/media controls 1120, or as might be downloaded via communication network interface 1114.

The graphics processor 1106 of FIG. 11 (or graphics card) executes graphics instructions received from the CPU 1104 to produce images for display on a display device (not shown). The graphics processor 1106 of FIG. 11 may transform objects from three-dimensional coordinates to two-dimensional coordinates, and vice versa. Graphics processor 1106 may use ray tracing to aid in the rendering of light and shadows in a game scene by simulating and tracking individual rays of light produced by a source. Graphics processor 1106 may utilize fast boot and load times, 4K-8K resolution, and up to 120 FPS with 120 hz refresh rates. Graphics processor 1106 may render or otherwise process images differently for a specific display device.

I/O processor 1108 of FIG. 11 may also allow for the exchange of content over a wireless or other communications network (e.g., IEEE 802.x inclusive of Wi-Fi and Ethernet, 5G, 4G, LTE, and 3G mobile networks, and Bluetooth and short-range personal area networks). The I/O processor 1108 of FIG. 11 primarily controls data exchanges between the various devices of the electronic entertainment system 1100 including the CPU 1104, the graphics processor 1106, controller interface 1110, hard disc drive/storage component 1112, communication network interface 1114, virtual reality interface 1116, sound engine 1118, and optical disc/media controls 1120.

A user of the electronic entertainment system 1100 of FIG. 11 provides instructions via a controller device communicatively coupled to the controller interface 1110 to the CPU 1104. A variety of different controllers may be used to receive the instructions, including handheld and sensor-based controllers (e.g., for capturing and interpreting eye-tracking-based, voice-based, and gestural commands). Controllers may receive instructions or input from the user, which may then be provided to controller interface 1110 and then to CPU 1104 for interpretation and execution. The instructions may further be used by the CPU 1104 to control other components of electronic entertainment system 1100. For example, the user may instruct the CPU 1104 to store certain game information on the hard disc drive/storage component 1112 or other non-transitory computer-readable storage media. A user may also instruct a character in a game to perform some specified action, which is rendered in conjunction with graphics processor 1106, inclusive of audio interpreted by sound engine 1118.

Hard disc drive/storage component 1112 may include removable or non-removable non-volatile storage medium. Saud medium may be portable and inclusive of digital video disc, Blu-Ray, or USB coupled storage, to input and output data and code to and from the main memory 1102. Software for implementing embodiments of the present invention may be stored on such a medium and input to the main memory via the hard disc drive/storage component 1112. Software stored on a hard disc drive may also be managed by optical disk/media control 1120 and/or communications network interface 1114.

Communication network interface 1114 may allow for communication via various communication networks, including local, proprietary networks and/or larger wide-area networks such as the Internet. The Internet is a broad network of interconnected computers and servers allowing for the transmission and exchange of Internet Protocol (IP) data between users connected through a network service provider. Examples of network service providers include public switched telephone networks, cable or fiber services, digital subscriber lines (DSL) or broadband, and satellite services. Communications network interface allows for communications and content to be exchanged between the various remote devices, including other electronic entertainment systems associated with other users and cloud-based databases, services and servers, and content hosting systems that might provide or facilitate game play and related content.

Virtual reality interface 1116 allows for processing and rendering of virtual reality, augmented reality, and mixed reality data. This includes display devices such that might be partial or entirely immersive virtual environments. Virtual reality interface 1116 may allow for exchange and presentation of immersive fields of view and foveated rendering in coordination with sounds processed by sound engine 1118 and haptic feedback.

Sound engine 1118 executes instructions to produce sound signals that are outputted to an audio device such as television speakers, controller speakers, stand-alone speakers, headphones, or other head-mounted speakers. Different sets of sounds may be produced for each of the different sound output devices. This may include spatial or three-dimensional audio effects.

Optical disc/media controls 1120 may be implemented with a magnetic disk drive or an optical disk drive for storing, managing, and controlling data and instructions for use by CPU 1104. Optical disc/media controls 1120 may be inclusive of system software (an operating system) for implementing embodiments of the present invention. That system may facilitate loading software into main memory 1102.

The systems and methods described herein can be implemented in hardware, software, firmware, or combinations of hardware, software and/or firmware. In some examples, systems described in this specification may be implemented using a non-transitory computer readable medium storing computer executable instructions that when executed by one or more processors of a computer cause the computer to perform operations. Computer readable media suitable for implementing the control systems described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application-specific integrated circuits. In addition, a computer readable medium that implements a control system described in this specification may be located on a single device or computing platform or may be distributed across multiple devices or computing platforms.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claims.

What is claimed is:

1. A method for distributing entitlements to one or more users, the method comprising:
detecting that a card has been docked with a first handheld device of a first user, wherein the first handheld device is configured to releasably hold and display the card while in a docked state;
reading a unique code from the card using the first handheld device;
transmitting the unique code from the first handheld device to a server associated with a database of user accounts;
associating within the database an account of the first user and the unique code; and
providing an entitlement to the first user in at least one of a digital environment or a physical environment responsive to the account of the first user and the unique code being associated.

2. The method of claim 1, wherein the digital environment comprises a video game.

3. The method of claim 2, wherein the entitlement includes one or more of an item, a skin, a resource, an achievement, or access to at least a portion of the video game.

4. The method of claim 1, wherein providing the entitlement to the first user comprises providing the first user with entry to a location within the physical environment.

5. The method of claim 1, further comprising one or more initial steps of associating the unique code with the entitlement or storing the unique code in the card in response to the first user purchasing the entitlement at a kiosk.

6. The method of claim 5, wherein the entitlement comprises access to at least a portion of a video game, and wherein providing the entitlement to the first user comprises preloading the at least a portion of the video game on a video game system of the first user.

7. The method of claim 1, further comprising one or more initial steps of associating the unique code with the entitlement or storing the unique code in the card in response to the first user winning a challenge in the digital environment.

8. The method of claim 1, further comprising one or more initial steps of associating the unique code with the entitlement or storing the unique code in the card in response to the first user bringing the card into proximity with a wireless transmitter in the physical environment.

9. The method of claim 1, further comprising providing the entitlement to a second user in response to detecting that the card has been docked with a second handheld device of the second user.

10. The method of claim 9, further comprising removing the entitlement from the first user in conjunction with providing the entitlement to the second user.

11. The method of claim 1, further comprising providing the entitlement to at least one other user who previously owned the card or whose user account was previously associated with the unique code in the database.

12. The method of claim 1, further comprising providing the entitlement to each user who previously owned the card or whose user account was previously associated with the unique code in the database.

13. A system for distributing entitlements to one or more users, the system comprising:
at least one processor; and
at least one memory programmed with instructions that cause the at least one processor to:
detect that a card has been docked with a first handheld device of a first user, wherein the first handheld device is configured to releasably hold and display the card while in a docked state;
read a unique code from the card using the first handheld device;
transmit the unique code from the first handheld device to a server associated with a database of user accounts;
associate within the database an account of the first user and the unique code; and
provide an entitlement to the first user in at least one of a digital environment or a physical environment responsive to the account of the first user and the unique code being associated.

14. The system of claim 13, wherein the digital environment comprises a video game.

15. The system of claim 14, wherein the entitlement includes one or more of an item, a skin, a resource, an achievement, or access to at least a portion of the video game.

16. The system of claim 13, wherein the entitlement includes providing the first user with entry to a location within the physical environment.

17. The system of claim 13, wherein the instructions cause the at least one processor to perform one or more initial steps of associating the unique code with the entitlement or storing the unique code in the card in response to the first user purchasing the entitlement at a kiosk.

18. The system of claim 17, wherein the entitlement comprises access to at least a portion of a video game, and wherein the instructions that cause the at least one processor to provide the entitlement to the first user include instructions for causing a video game system of the first user to preload the at least a portion of the video game.

19. The system of claim 13, wherein the instructions cause the at least one processor to perform one or more initial steps of associating the unique code with the entitlement or storing the unique code in the card in response to the first user winning a challenge in the digital environment.

20. The system of claim 13, wherein the instructions cause the at least one processor to perform one or more initial steps of associating the unique code with the entitlement or storing the unique code in the card in response to the first user bringing the card into proximity with a wireless transmitter in the physical environment.

21. The system of claim 13, wherein the instructions further cause the at least one processor to provide the entitlement to a second user in response to detecting that the card has been docked with a second handheld device of the second user.

22. The system of claim 21, wherein the instructions further cause the at least one processor to remove the entitlement from the first user in conjunction with providing the entitlement to the second user.

23. The system of claim 13, wherein the instructions further cause the at least one processor to provide the entitlement to at least one other user who previously owned the card or whose user account was previously associated with the unique code in the database.

24. The system of claim 13, wherein the instructions further cause the at least one processor to provide the entitlement to each user who previously owned the card or whose user account was previously associated with the unique code in the database.
